(19) United States
(12) Patent Application Publication
(10) Pub. No.: US 2005/0160255 A1
(43) Pub. Date: Jul. 21, 2005

(54) Information processing device and program

(75) Inventors: Toshiro Obitsu, Kawasaki (JP); Hisamichi Higuchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/024,490

(22) Filed: Dec. 30, 2004

Related U.S. Application Data
(63) Continuation-in-part of application No. 10/910,423, filed on Aug. 4, 2004.

(30) Foreign Application Priority Data
Jan. 15, 2004 (JP) 2004-008544
Sep. 24, 2004 (JP) 2004-277750

(51) Int. Cl. G06F 15/177

(52) U.S. Cl. 713/1

(57) ABSTRACT

Receiving a boot instruction of the operating system, performing management by making a first recording area recognizable to the first operating system booted based on the boot instruction in an operating status of the first operating system stored in the first recording area, and making a second recording area unrecognizable that is stored with the second operating system.

### BACKGROUND OF THE INVENTION

The present invention relates to an information appliance having a television function.

Personal computers incorporating a television function have been put on the market and got available over the recent years. Consequently, users of the personal computers execute information processing on the personal computers or access the Internet via the personal computers on one hand, and can listen to and watch TV programs from on the personal computers on the other hand. The TV function becomes, however, utilizable by booting a television application after a normal OS (Operating System) has been booted.

The normal OS (hereinafter called a basic OS) must be booted in order to listen to and watch the television broadcasting on the conventional personal computers. For this reason, it is impossible to listen to and watch the television broadcasting unless the basic OS is normally booted. Further, a certain amount of time is required till it is possible to listen to and watch the television broadcasting after power-on of a power source.

Moreover, there was a device including a TV tuner provided in a monitor independently of the TV function of the personal computer. Pieces of information or images from the personal computer are displayed on this monitor of the device, while a received program of the television broadcasting can be displayed on the monitor directly from the TV tuner. Hence, there was no occurrence of the problem about whether the basic OS is normally booted or not, or whether the boot time is short or long.

This device, however, requires a TV tuner on the personal computer side in order to interface with a function of the personal computer and additionally requires another TV tuner on the monitor side. In this type of system, the television broadcasting can be displayed within a short period of time. But, this system requires two pieces of TV tuners, resulting in an increase in costs.

On the other hand, a known prior art is that a different OS for a dedicated function from the normal OS is prepared to make the device perform operations specialized in the dedicated function, and the OS to be booted is switched over according to the condition. (Example: Patent documents 1 and 2).

[Patent Document 1]

Japanese Patent Application Laid-Open Publication No. 2002-132393.

[Patent Document 2]

Japanese Patent Application Laid-Open Publication No. 2002-288126.

### SUMMARY OF THE INVENTION

Accordingly, the conventional system could not actualize the television display within a short period of time without any increase in costs.

Further, the prior art does not support any schemes for preventing the breakage of information of other OS, applications running on the OS and etc. while actualizing a short-time boot of the OS, when an OS is in exchange and run.

The invention aims at, in an information appliance installed with at least two operating systems, actualizing a technology of preventing the breakage of the information of the mutual operating systems. The invention further aims at, in an information appliance having a television function, actualizing a technology of booting the television function within a short period of time without increasing hardware.

For solving the problems, the invention adopts the following unit. Namely, according to the invention, an information processing device on which a first operating system and a second operating system are operable, includes a receiving unit receiving a boot instruction of the operating system, and a control unit performing management by making a first recording area recognizable to the first operating system booted according to the boot instruction while the first operating system stored in the first recording area is running, and making a second recording area storing the second operating system unrecognizable.

According to the invention, the management is conducted such that while the first operating system is running, the first recording area is set recognizable to the first operating system, and the second recording area storing the second operating system is set unrecognizable. Hence, there is a decreasing possibility that the second recording area storing with the second operating system might be updated, broken and so forth due to the process running on the first operating system. Moreover, according to the invention, the television broadcasting signal receiving process can be booted simply and efficiently by preparing a specialized OS for the function suited to the receipt of the television broadcasting signal as the second operating system.

Preferably, the first recording area and the second recording area may be recognized by the operating system based on the first identifying information but not recognized based on the second identifying information, and the control unit may, when booting the second operating system according to the boot instruction, execute such setting that the first recording area is managed based on the second identifying information, and may include a booting unit for booting the second operating system.

According to the invention, the operating system is capable of recognizing the first recording area and the second recording area based on the first identifying information. The setting in the normal status is that the first recording area is managed based on the first identifying information, and the second recording area is managed based on the second identifying information. In this status, the operating system recognizes the first recording area but is unable to recognize the second recording area. It is therefore possible to reduce the possibility in which the second operating system and the information managed by the second operating system might be changed during the first operating system is running. On the other hand, when booting the second operating system, the setting is that the first recording area is managed based on the second identifying information. With this scheme, it is possible to reduce the possibility in which the first operating system and the information managed by the first operating system might be changed during the second operating system is running.

Preferably, the booting unit may boot the second operating system in a way that omits part of a process that should be run when the first operating system is booted. This is because the system may be built up by the specialization in, e.g., the function suited to the receipt of the television broadcasting signal, in booting the second operating system. Therefore, according to the invention, the second operating system can be booted within a short period of time.

Preferably, the booting unit may include a judging unit judging whether the second recording area recognized based on the second identifying information exists or not, and, if unable to recognize the existence of the second recording area, may boot the first operating system. Hence, according to the invention, the first operating system can be booted as usual in such a device that the second recording area is not provided.

The omitted process is, for example, a security check, etc. about resources or information managed by the operating system.

Further, an information processing device according to the invention may be constructed to further comprise a downloading unit downloading, via a network, data used during an operation of the second operating system during an operation of the first operating system. In this case, the recording unit is structured to further include a third recording area recognized by both of the first operating system and the second operating system. Further, the downloading unit records the downloaded data in the third recording area. With this construction, for instance, if the second operating system does not have a connecting function to the network, in other words, even when the downloading unit does not operate during the operation of the second operating system, the data necessary for the second operating system can be downloaded from the network and can be recorded recognizably to the second operating system.

More specifically, for example, when the data to be downloaded by the downloading unit is data used during the operation of the second operating system and also data for updating a program of the second operating system, the second operating system includes the following updating unit, whereby the updating (update) of the second operating system itself can be actualized. The updating unit is unit for updating the program of the second operating system by use of the data recorded in the third recording area during the operation of the second operating system. With this configuration, even when the second operating system does not have the connecting function to the network, the program of the second operating system can be updated.

Further, the invention may be a method by which a computer or other device, machine, etc. executes any one of the aforesaid processes. Moreover, the invention may also be a program for making the computer or other device, machine, etc. actualize any one of the aforesaid processes. Still further, the invention may take a form that such a program is stored on a recording medium readable by the computer, etc.

According to the invention, in an information appliance with at least two types of operating systems installed, the breakage of the information of the mutual operating systems can be prevented. Further, the actualization of preventing the information breakage enables an omission of a variety of check processes for the operating system and the actualization of booting the operating system within a short period of time.

Moreover, according to the invention, in an information appliance having a television function, the television function can be booted within a short period of time without increasing hardware.

### DESCRIPTION OF THE DRAWINGS

FIG. 1 is a view of a configuration of an information processing device according to a best mode of the invention;

FIG. 2 is a view of a configuration of a remote controller 2;

FIG. 3 is a hardware block diagram of an information processing device body;

FIG. 4 is a flowchart showing a process at power-on of the information processing device;

FIG. 5 is a view of an architecture of a network system for downloading update data;

FIG. 6 is a diagram showing a display example of a liquid crystal display 12;

FIG. 7 is a diagram showing a display example of the liquid crystal display 12;

FIG. 8 is a flowchart showing a processing example when updating;

FIG. 9 is a flowchart showing a processing example when updating;

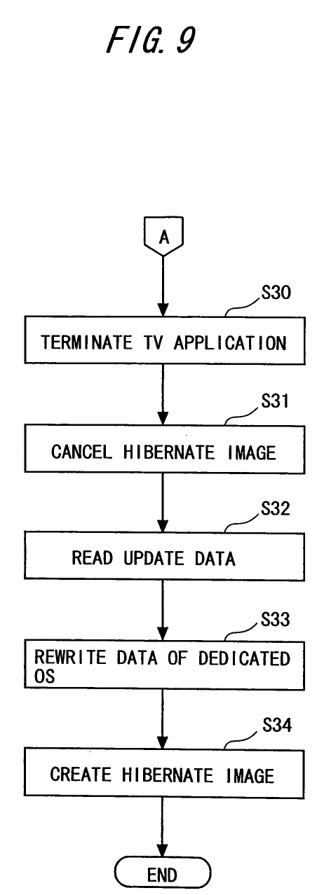

FIG. 10 is a flowchart showing an operational example of the network system; and

FIG. 11 is a diagram showing a display example of the liquid crystal display 12.

### DETAILED DESCRIPTION OF THE INVENTION

An information processing device according to a best mode (hereinafter called an embodiment) for carrying out the invention, will be described below with reference to the drawings. A configuration of the following embodiment is just an exemplification, and the invention is not limited to the configuration of the following embodiment.

Outline of Functions

Two pieces of software, i.e., a normal basic OS and a dedicated OS are pre-installed in this information processing device. This dedicated OS has a simplified function specialized in receiving television broadcasting and is therefore called a simple OS. A period of time till a television function is started up, is reduced by booting this dedicated OS in a short time.

Further, a normal type of information device such as a personal computer, etc. has only one button of a power source. By contrast, the present information processing device is prepared with a button (which is called a dedicated function button) different from the normal power button in order to boot the dedicated OS.

BIOS (Basic Input/Output System) (which corresponds to a receiving unit, a control unit and a booting unit) built in the information processing device, distinguishes between an operation via the power button and an operation via the dedicated function button. Then, the BIOS boots the basic OS upon the input of the power button. On the other hand, the BIOS boots the dedicated OS upon the input of the dedicated function button.

This being thus done, the basic OS and the dedicated OS are previously stored in different segmented areas (hereinafter called partitions). Then, the BIOS is set so that the OS's are respectively booted from its own partition, depending on which button, the power button or the dedicated function button, the input is given from. This mechanism enables the dedicated OS to be booted upon the input of the dedicated function button.

Further, the embodiment aims at booting the dedicated OS within a short time, and therefore information is stored in a hibernate status. Namely, a memory image is stored on a hard disk in an as executed status of plural processes (tasks) configuring an operation of the dedicated OS. Such a memory image will hereinafter be referred to as a hibernate image.

Therefore, applications and other pieces of information, which are used for process of the other dedicated OS and the dedicated OS during the basic OS is running, must be prevented from being rewritten. Such being the case, a scheme of the information processing device is that the partition stored with the dedicated OS is set unrecognizable from the basic OS during the execution of the basic OS. This mechanism makes the dedicated OS partition unrecognizable from the basic OS and from a program running on the basic OS even if the basic OS is booted, and it never happens that the information in the dedicated OS partition is rewritten. This scheme enables the hibernate image to be retained and the dedicated OS to be booted within a short time.

The partition stored with the dedicated OS has an ID of this partition (hereinafter called a partition ID), that is different from ID of a normal partition, therefore the partition is not accessed when remaining unchanged. Accordingly, normally, the dedicated OS can not be booted. Further, a capacity for the disk image can be reduced because of installing none of such a driver, and a period of processing time expended for restoring the disk image back to a memory can be reduced.

According to the information system, a driver program (e.g., disk.sys) of the hard disk is changed. Namely, the information processing device recognizes whether the input is the power button input or the dedicated function button input, and reads the partition ID based on the input, on a driver level. With this scheme, the BIOS boots the OS in each partition, according to the power button input or the dedicated function button input.

Moreover, a mouse, a keyboard, LAN and MODEM are set incapable of functioning in driver during the dedicated OS is running on the information processing device. This setting makes a user unable to change the data within the information processing device during the dedicated OS is running.

Disk.sys exemplified above is categorized as a driver for controlling an IDE (Integrated Drive Electronics) interface. According to the information processing device, the partition ID is converted within the driver by use of the IDE driver. In the information processing device, a partition ID of the normal partition is set to 07h (partition ID=07h). The basic OS and the driver program on the information processing device recognize the partition assigned 07h (partition ID=07h) as a legitimate partition, and input and output data to the recognizable partition.

On the other hand, a partition ID of the dedicated OS partition stored with a television receiving application (corresponding to a unit for controlling receiving conditions) is set to 12h (partition ID=12h). The partition ID “12h” is not normally used on the basic OS, and hence the partition assigned 12h is, as viewed from the normally-booted basic OS, recognized as an unknown partition. It is therefore impossible to access the partition stored with the television receiving application while the basic OS is running. Hence, it does not happen that the dedicated OS is broken during the normal basic OS is running.

Further, when the dedicated OS is booted, the driver program reads the partition (partition ID=07h) of the normal basic OS so as to be exchanged for 12h. With this scheme, conversely when the dedicated OS is running, the area stored with the normal basic OS is recognized as an unknown area. Thus, the basic OS and the dedicated OS are stored completely independently of each other, and run separately. Accordingly, there is no occurrence of such a problem that the other OS is carelessly broken, or the security can not be maintained during one OS is running, due to the process during the other OS is running.

Device Configuration

The information processing device can be actualized as an information device exemplified by a personal computer, a PDA (Personal Digital Assistant), a cellular phone and so on. The following discussion shows an example of actualizing the information processing device by way of a personal computer.

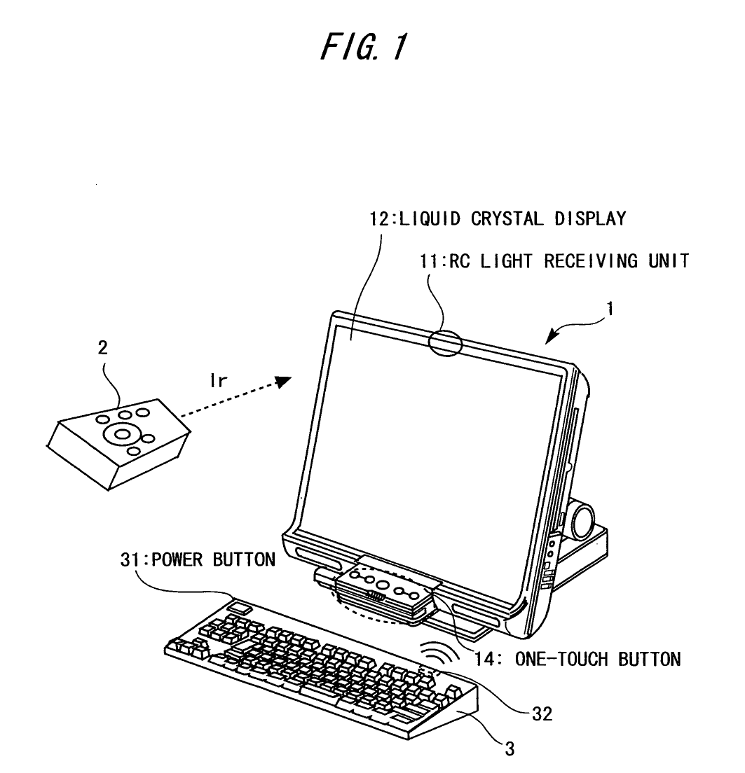

FIG. 1 is a view showing a configuration of the information processing device. The information processing device includes a device body 1, a remote controller 2 (hereinafter be abbreviated to “RC 2” as the case may be) for controlling the device body 1, a keyboard 3 interfaced with the device body 1, and an unillustrated mouse.

The device body 1 has a liquid crystal display 12, a screen embracing a periphery of the liquid crystal display 12, a RC light receiving unit 11 provided on an upper portion of the screen chassis, and a one-touch button 14 provided on a front side of the screen chassis and at a lower central portion of the liquid crystal display 12. Further, a CPU for providing functions of the information processing device, a memory (including a RAM and a ROM), a hard disk, a TV tuner and a variety of controllers are built in the device body 1.

The RC light receiving unit 11 receives infrared-ray signals from the remote controller 2 and transmits the signals to the devices within the device body 1. The RC light receiving unit 11 is a so-called Ir (Infrared) device.

In the information processing device, the keyboard 3 and the unillustrated mouse are linked via wireless signals to the device body 1. The keyboard 3 and the mouse are so-called wireless keyboard and wireless mouse. The embodiment of the invention is not, however, limited to the information processing device having this type of wireless keyboard and wireless mouse. The invention can be applied to an information processing device having a wired keyboard and a wired mouse that are connected via cables.

As shown in FIG. 1, the keyboard 3 includes a wireless interface module 32 and a power button 31. Pressing state of respective keys on the keyboard 3 and the power button 31, are transmitted via the wireless interface module 32 to the device body 1. Note that the power button 31 is provided on the keyboard 3 but is not under the control of the keyboard driver, because of the power button 31 is controlled by differently from the respective keys. Hence, the device body 1 (BIOS) can recognize that the power button 31 is pressed even when the keyboard driver is not installed for a booting status of the dedicated OS. Moreover, the wireless interface module 32 is not limited to a specific architecture in the embodiment of the invention.

The wireless interface module 32 may utilize any kinds of wireless signals such as the infrared-rays, electromagnetic waves, sound waves, etc. When the wireless interface module 32 uses the infrared-rays, the RC light receiving unit 11 may also be made to receive the infrared-rays. When the wireless interface module 32 uses electromagnetic waves, there is no limit to application of the communications standards. For example, the communications based on Bluetooth standards, other communications standards as used for wireless LAN, etc. and using independent communication procedures are also available. Note that the power button 31 (corresponding to a unit for detecting a first user's operation) of the keyboard 3 in the information processing device is employed for booting the so-called basic OS.

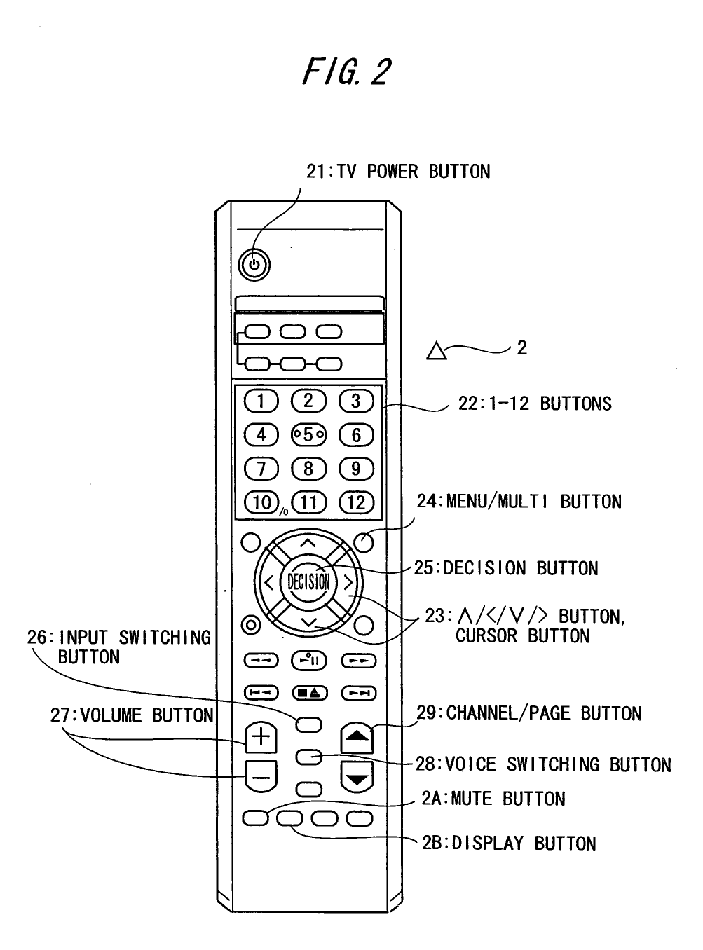

FIG. 2 is a view showing a configuration of the remote controller 2. The remote controller 2 has a TV power button 21, 1-12 buttons 22, cursor buttons 23, menu/multi buttons 24, a decision button 25, an input switchover button 26, sound volume buttons 27, a voice switchover button 28, channel/page buttons 29, a mute button 2A, a display button 2B and an unillustrated light emitting unit.

Among these components, the TV power button 21 (corresponding to a dedicated function button and a unit for detecting a second user's operation) is employed for booting the dedicated OS for simply receiving the television broadcasting. Namely, when the TV power button 21 is pressed during power off of the information processing device, and if predetermined boot conditions are set, the dedicated OS and an application for receiving the television broadcasting are booted. The dedicated OS enables a user to listen to and watch the television broadcasting in a shorter period of time than in the case of booting the basic OS.

The 1-12 buttons 22 is used for selecting TV channels 1 through 12. According to the embodiment of the invention, however, the number of selectable channels and the selectable channel numbers are not limited to the range of 1 through 12, and may properly changed according to a state of the television broadcasting. Moreover, channel numbers exceeding “12” may also be selectable by combining the buttons “1” through “12”.

The cursor buttons 23 are used for selecting menu items on the application for receiving the television broadcasting or on other application of the information processing device. The cursor buttons 23 are employed when moving the cursor on, e.g., a menu screen for selecting the menu items.

When the menu/multi buttons 24 are pressed, the information processing device displays menus on the screen. Further, the decision button 25 is used for deciding an option on the menu. The input switchover button 26 is employed for switching over an input destination of video signals displayed during an execution of the television broadcast receiving application. In the example of the information processing device, every time the input switchover button 26 is pressed, the input destination of the video signals is switched over in the sequence of a TV tuner, a video input terminal and a S-video (Separate Video) signal terminal.

The sound volume buttons 27 are used for an output adjustment of the sound volume of the television broadcasting received. The mute button 2A is employed for an ON/OFF switchover of the sound volume output of the television broadcasting received. Further, the display button 2B is used for switching over display of receiving states (the receiving channel, the sound volume, etc.) of the present television broadcasting on the screen.

Note that the remote controller 2 includes an unillustrated infrared-ray emitting unit and transmits the pressing state of each of the buttons as discussed above, to the device body 1. The emission and the receipt of the infrared-rays are broadly known, and hence their explanations are omitted.

Hardware Architecture

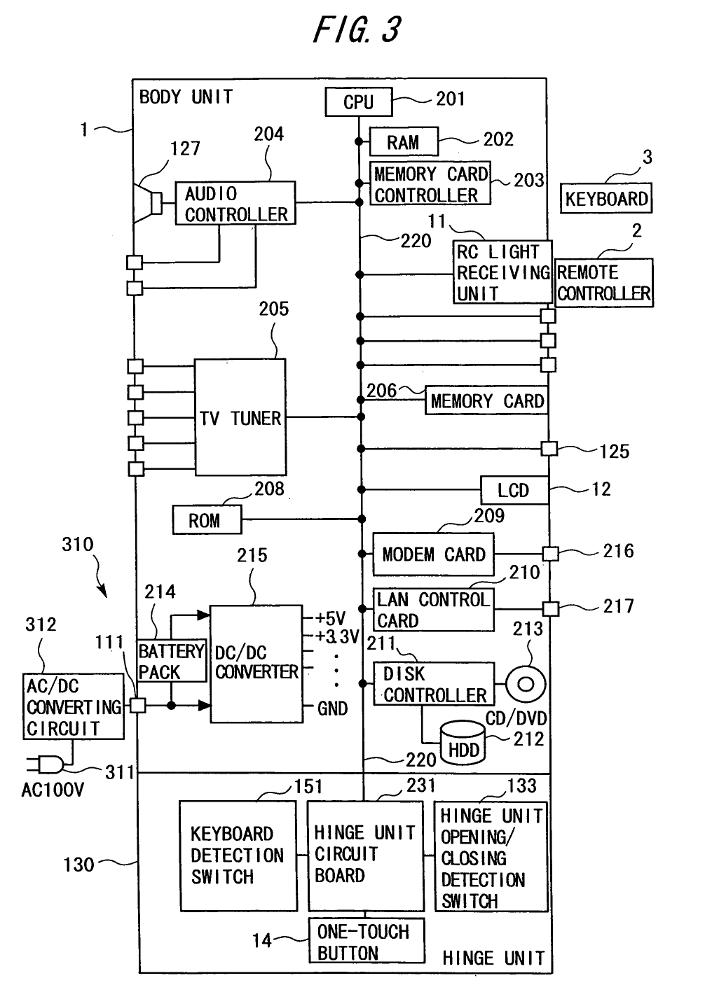

FIG. 3 shows a hardware block diagram of the device body 1. The device body 1 includes a CPU 201 for controlling the information processing device, a RAM 202 for storing programs executed on the CPU 201 or data processed by the CPU 201, a memory card controller 203 for controlling an access to a memory card, an audio controller 204 for acoustic outputs (voices and sounds), a speaker 127 for audibly outputting the outputs of the audio controller 204, a RC light receiving unit 11 for receiving the infrared-ray signals from the remote controller 2, a TV tuner 205 for receiving the television broadcasting, a memory card slot 206 through which the memory card is inserted, a liquid crystal display 12 for displaying information (pictures, character information, etc.) of the television broadcasting received by the TV tuner 205 or displaying information processed by the CPU 201, a rewritable ROM 208 for storing the BIOS, a MODEM card 209 for accessing an external network via a telephone line, a LAN control card 210 for accessing the LAN, a power source unit 310 (including an AC/DC converting circuit 312, a battery pack 214 and a DC/DC converter 215), a hard disk drive unit 212, a CD/DVD drive unit 213, and a disk controller 211 for controlling respective drive units of the hard disk and the CD/DVD.

Moreover, the device body 1 is connected through a hinge member to a hinge unit 130. The hinge unit 130 has a keyboard detection circuit 151 for detecting the signals from the keyboard 3, a hinge unit opening/closing detection switch 133 for detecting opening/closing states of the hinge unit, a hinge unit circuit board 231, and a variety of one-touch buttons 14 provided on the front side of the device body 1.

The TV tuner 205 selects and receives a channel indicated by the television receiving application executed on the CPU 201. Pictures of the channel received are outputted via an unillustrated graphics unit to the liquid crystal display 12. Further, sounds of the channel received are processed by the audio controller 204 and thus outputted from the speaker 127.

The infrared-ray signals from the remote controller 2 are received by the RC light receiving unit 11 and transmitted to the CPU 201 through an unillustrated chip set. The wireless signals from the keyboard 3 are likewise received by an unillustrated wireless signal receiving unit and transmitted via an unillustrated chip set to the CPU 201. As described earlier, however, in the case of the device using the infrared-ray signals as the wireless signals from the keyboard 3, the RC light receiving unit 11 may receive the wireless signals.

The hard disk driven by the hard disk drive unit 212 has a plurality of segmented areas (which may also be called partitions, logical drives, logical units or logical devices, etc.). Among these partitions, the partition stored with the normal OS is assigned 07h as a partition ID (partition ID=07h) and is recognized as the partition to which the normal OS and the driver program have an access. On the other hand, the partition stored with the TV receiving dedicated OS is assigned 12h as a partition ID (partition ID=12h).

Setting of OS Boot Conditions

The information processing device is capable of performing valid/invalid setting of the dedicated OS (TV function) boot through a user interface operation by user (BIOS setup) provided by the BIOS.

(1) Case of Setting the Dedicated OS Boot Valid by BIOS

(1-1) When Information Processing Device is in Shutdown Status (OFF-State of Power Source);

In this case, when detecting that the TV power button 21 of the remote controller 2 has been pressed, the BIOS boots the dedicated OS. On the other hand, when detecting that power button 31 provided on the keyboard 3 has been pressed, the BIOS boots the normal basic OS.

(1-2) When Information Processing Device is in the Status that Dedicated OS is Running;

In this case, when detecting that the TV power button 21 of the remote controller 2 has been pressed, the BIOS terminates the dedicated OS. Further, when detecting that power button 31 provided on the keyboard 3 has been pressed, the BIOS also terminates the dedicated OS. Namely, during the dedicated OS is running (during the television broadcasting receiving application is running), even when any one of the TV power button 21 and the power button 31 provided on the keyboard 3 is pressed, the information processing device terminates the television receiving function.

(1-3) When Information Processing Device is in the Status that Basic OS is Running;

In this case, when detecting that the TV power button 21 of the remote controller 2 has been pressed, the BIOS invalidates this pressing. Namely, the BIOS makes no reaction. This scheme prevents the power source of the information processing device body from being carelessly switched OFF by the remote controller 2.

On the other hand, when detecting that the power button 31 on the keyboard 3 has been pressed, the BIOS executes a process depending on the setting (which is the setting of the power source option) of the normal basic OS. For example, the termination of the basic OS (the power source OFF) or a shift to the standby status can be selected as the power source option.

(2) Case of Setting Boot of Dedicated OS Invalid

(2-1) When Information Processing Device is in Shutdown Status (Power Source OFF Status);

In this case, when detecting that any one of the TV power button 21 of the remote controller 2 and the power button 31 on the keyboard 3 has been pressed, the BIOS boots the basic OS.

(2-2) When Information Processing Device is in the Status that Basic OS is Running;

In this case, when detecting that any one of the TV power button 21 of the remote controller 2 and the power button 31 on the keyboard 3 has been pressed, the BIOS executes a process depending on the setting of the normal basic OS (which is the setting of a power source option). The power source option is exemplified such as the termination of the basic OS (the power source OFF) or the shift to the standby status.

Processing Flow

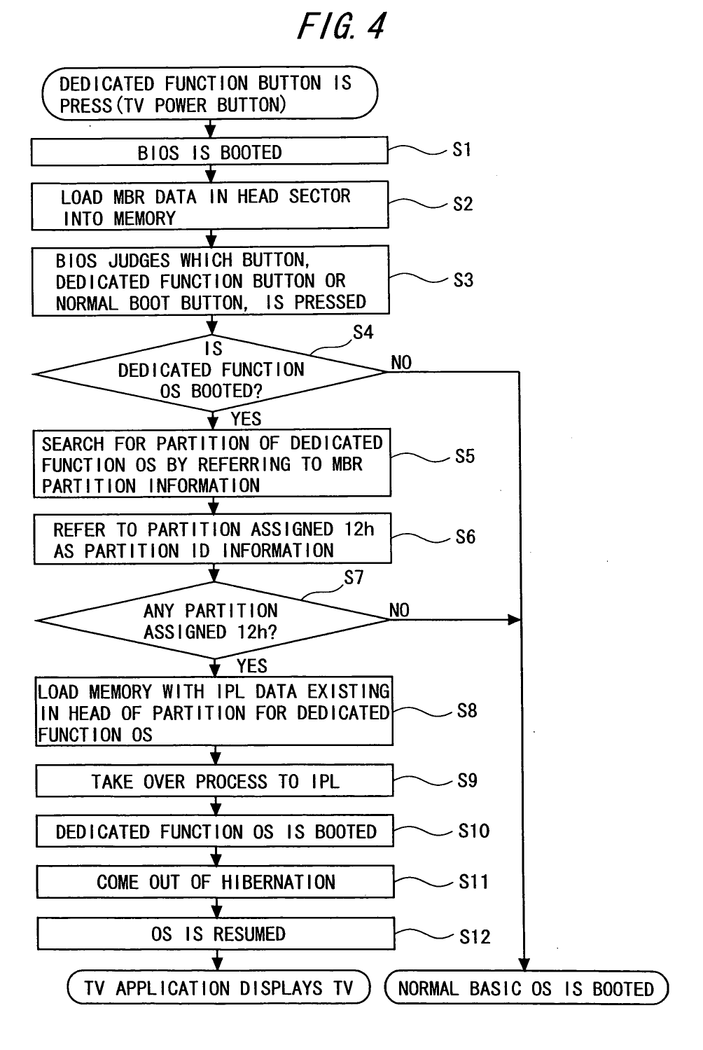

FIG. 4 shows a process at power-on of the power source of the information processing device. This process is a process in a state where the boot of the dedicated OS is set valid through the user interface provided by the BIOS, and the power source is switched OFF by this setting. Moreover, in an initial status, the partition ID of the hard disk partition stored with the basic OS is set to 07h, while the partition ID of the partition stored with the dedicated OS is set to 12h.

This process is booted by pressing the TV power button 21 of the remote controller 2 (or the power button 31 on the keyboard 3). In this process, to start with, the BIOS stored on the ROM 208 is booted (S1). Then, the BIOS loads a master boot record (MBR) stored in a head sector of the hard disk into the memory (the RAM 202) (S2).

Next, the BIOS judges whether the pressed button is the TV power button 21 (which is also simply called a dedicated function button) for booting the dedicated OS or the power button 31 (which is also simply called a boot button) for booting the normal basic OS (S3). Then, when judging that the TV power button 21 is not pressed (NO in S4), the BIOS shifts the control to the partition assigned 07h as the partition ID in accordance with the normal procedures. The normal basic OS is thereby booted (wherein the CPU 201 executing the BIOS corresponds to a receiving unit and a booting unit).

On the other hand, if the judgment in S4 is that the TV power button 21 has been pressed, the BIOS searches for the partition of the dedicated OS by referring to the partition information in the master boot record(S5). Namely, the BIOS searches for the partition assigned 12h as the partition ID (S6).

As a result, if none of the partitions assigned 12h as the partition ID are discovered (No in S7), the BIOS shifts the control to the partition assigned the partition ID “07h” in accordance with the normal procedures. The normal basic OS is thereby booted.

Whereas if the judgment in S7 is that the partition assigned the partition ID “12h” is discovered, the BIOS shifts the control to this partition (of which the partition ID is 12h). Then, the BIOS loads IPL (Initial Program Loader) data existing in the head of the partition into the memory (S8).

Subsequently, the BIOS takes over the process to the IPL (S9). To be more specific, the control of the CPU 201 is taken over to the IPL. The dedicated OS stored in this partition is thereby booted. The dedicated OS has been stored as the memory image in the hibernate status on the hard disk, and is therefore restored as it remains unchanged into the memory (the RAM 202). Then, the dedicated OS is recovered (S12), and the television receiving application is booted.

Hereafter, the information processing device, under the control of the television receiving application, indicates a receiving channel to the TV tuner 205, and makes the TV tuner 205 to receive the television broadcasting of the channel selected by the user. Moreover, the information processing device, under the control of the television receiving application, indicates a sound volume of the receiving channel to the audio controller 204. Such a television broadcasting receiving process by the television receiving application has already been broadly known, and hence its explanation is omitted.

In a subsequent process during the execution of the dedicated OS, the access to the hard disk is executed by the dedicated driver program. The driver program reads the partition ID “12h” (ID=12h) as 07h (ID=07h). Further, the driver program processes the partition assigned the partition ID “07h” (ID=07h) as the partition assigned the partition ID “12h” (ID=12h). Accordingly, in the subsequent process, the partition having the partition ID “12h” (ID=12h) is recognized, and it follows that the partition having the partition ID “07h” (ID=07h) exists as an unknown partition that is recognizable but inaccessible by the driver (wherein the CPU 201 executing the driver program used by the basic OS and the dedicated driver program, corresponds to a control unit).

Moreover, the dedicated OS provides such setting that the mouse, the keyboard, the LAN and the MODEM, which are utilized based on the normal basic OS, do not function on the driver-by-driver basis (namely, the drivers that support these devices and the LAN networking are so installed as to function when the basic OS is running). Accordingly, there is no necessity of checking these pieces of hardware. Further, this scheme makes the user unable to change the data within the information processing device, during the dedicated OS is running. It is therefore unnecessary to execute security checks of resources and data managed by the dedicated OS. It is checked during the basic OS is running whether a password and a variety of set values of the BIOS are changed or not, and so forth. The dedicated OS does not, however, necessitate these checks. Accordingly, the dedicated OS can be booted within a short period of time.

As discussed above, according to the information processing device, the television receiving application is installed into the dedicated OS, whereby the setting of the dedicated OS is just for executing the driver for listening to and watching the television broadcasting or for the display thereof. Hence, the dedicated OS can be booted within a short period of time. Moreover, the boot of the dedicated OS is the process of restoring from the hibernate status, and the process requiring a much shorter period of time can be actualized.

Then, this boot is executed by the simple operation via the dedicated button named the TV power button 21. The dedicated OS can be thereby simply booted within a short period of time without burdening the user with any task, and as a result a preparation for listening to and watching the television broadcasting is made within a short period of time. In this case, as compared with a system implementing a second piece of TV tuner on the monitor side with no intermediary of the OS, the cost can be reduced down and the system can be simplified because of utilizing only the single TV tuner. As a consequence, a space for implementing the components can be reduced. Further, the dedicated OS is configured in a way that deletes unnecessary components out of the functions of the original basic OS, and can therefore simply attain its extended functions.

Moreover, in the information processing device explained in the embodiment, the basic OS and the dedicated OS are stored in the different partitions identified with the different partition IDs. Hence, the partition stored with the dedicated OS is unrecognizable to the basic OS in the basic OS execution status. The dedicated OS in the hibernate status can be therefore retained in safety. Moreover, the partition stored with the basic OS is unrecognizable to the dedicated OS in the dedicated OS execution status. It is not therefore required to take into consideration a write-access to the resources or the information of the information processing device through the user's operation during the dedicated OS is running, whereby the security checks can be simplified.

### MODIFIED EXAMPLES

The embodiment has exemplified the information processing device in which the dedicated OS partition recognized by the partition ID “12h” (partition ID=12h) is stored with the television receiving application. The embodiment of the invention is not, however, limited to this scheme. For instance, the television receiving application may also be stored in both of the partition stored with the dedicated OS and the partition stored with the basic OS.

The embodiment has exemplified the use of the power button 21 of the remote controller 2 when booting the dedicated OS for receiving the television broadcasting. The embodiment of the invention is not, however, limited to this scheme. For example, the chassis of the device body 1 may be provided with a button for booting the dedicated OS for receiving the television broadcasting. Further, the mouse may also be provided with the button for booting the dedicated OS for receiving the television broadcasting. Moreover, the button for booting the dedicated OS for receiving the television broadcasting may also be provided on the keyboard 3 separately from the power button 31.

According to the embodiment, Disk.sys defined as the driver for controlling the IDE interface reads one partition ID of the partition in exchange for the other, thereby booting the basic OS and the dedicated OS in distinction. The invention is not, however, confined to the storage device using the IDE interface and can be carried out in the same procedures as the above-mentioned even in the case of booting the OS from on storage devices using other types of interfaces.

Namely, the invention can be carried out by providing two pieces of boot buttons on condition that the system has the function of distinguishing between the recognizable partition and the unrecognizable partition, the function of replacing the recognizable partition and the unrecognizable partition with each other, and the function of booting the OS from the partition that could be recognized.

Moreover, another possible scheme according to the invention is not that, as described above, the recognizable partition and the unrecognizable partition are replaced with each other but that information for making unrecognizable the partition stored with the other OS is simply set through the boot target OS.

Readable-by-Computer Recording Medium

A program for making a computer actualize any one of the functions can be recorded on a readable-by-computer recording medium. Then, the computer reads and executes the program on this recording medium, thereby enabling the function thereof to be provided.

Herein, the readable-by-computer recording medium connotes a recording medium capable of storing information such as data, programs, etc. electrically, magnetically, optically and mechanically or by chemical action, which can be read by the computer. Among those recording mediums, the mediums demountable out of the computer are, e.g., a flexible disk, a magneto-optic disk, a CD-ROM, a CD-R/W, a DVD, a DAT, an 8 mm tape, a memory card, etc.

Further, a hard disk, a ROM (Read Only Memory) and so on are classified as recording (storage) mediums fixed within the computer.

Update of Dedicated OS

By the way, the dedicated OS has a simplified function for executing the quick booting as described above. Hence, there might be a case in which the dedicated OS is, for instance, if the security function was deleted, so designed as not to have a networking function in order to maintain the security. Further, merely for simplification, there might be a case in which the dedicated OS is so designed as not to have a connecting function to the network.

On the other hand, over the recent years, a technology by which the information processing device performs updating by downloading an update file via the network, has been spread as a technology for updating the OS and the applications that are installed into the information processing device such as the personal computer, etc. The dedicated OS is, if having none of the network connecting function, however, incapable of acquiring the update file via the network. Therefore, an update file distributor (e.g., a provider of the dedicated OS, a dealer of selling the information processing device preinstalled with the dedicated OS, and so on) has hitherto been required to take a measure such as individually sending by mail a storage medium (a recovery medium) stored with the update file for the dedicated OS to the user. The measure such as mailing, etc. was a burden on the distributor in terms of a cost and an operation. Therefore, a technology capable of updating the dedicated OS via the network is demanded. The technology, which will be described as below, aims at providing a device and a method for actualizing, via the network, the updating of the dedicated OS having none of the network connecting function.

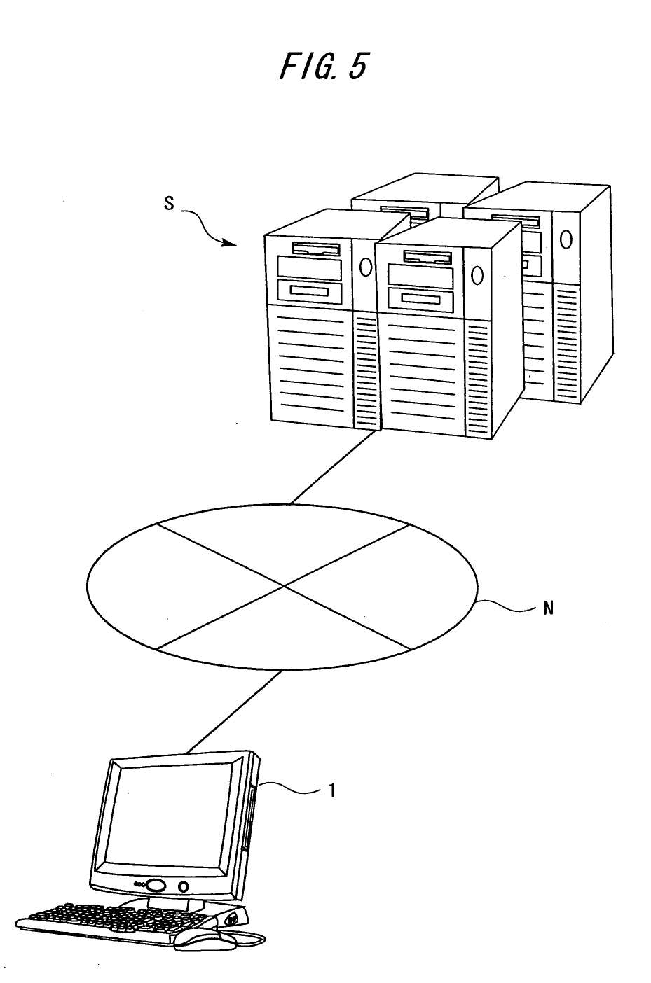

FIG. 5 is an explanatory view showing an outline of architecture of the network system in the embodiment. As shown in FIG. 5, the network system in the embodiment includes a device body 1 and a server S that are connected to a network N such as the Internet, etc. The device body 1 has a communication device, etc. connected to the network N. The device body 1 is preinstalled with a predetermined program, etc. for actualizing a variety of processes hereinafter described. Note that a plurality of device bodies 1, though FIG. 5 illustrates only the single device body 1, may be connected to the network N.

The server S is a general type of computer such as a workstation, etc., and includes a computer body, a storage device such as a hard disk device, etc. connected to this computer body, and a communication device, etc. connected to the network N. The server S may be provided with an input device such as a keyboard, a mouse, etc., and a display device like a display and so forth. The server S is preinstalled with a predetermined program, etc. for actualizing a variety of processes that will be explained later on.

In the device body 1, a data-readable partition (hereinafter called an [update data partition]) recognized by the dedicated OS, is provided within the partition stored with the basic OS. Namely, the partition stored with the basic OS is provided with a partition (which is a partition specified by, e.g., partition ID=07h) unrecognizable to the dedicated OS and with a partition (which is a partition specified by, e.g., partition ID=08h) recognizable to the dedicated OS. At this time, the partition recognizable to the dedicated OS may further be provided with a partition (hereinafter referred to as a [flag partition]: a partition specified by, e.g., partition ID=09h) in which the data is rewritable by the dedicated OS and with a non-rewritable partition (which is a partition specified by, e.g., partition ID=08h).

The basic OS, when downloading the update data of the dedicated OS via the network N, writes the downloaded update data in the update data partition. At this time, if provided with the flag partition, the basic OS may write, in the flag partition, an identifier (e.g., “1” expressed by 1 bit) indicating that a new piece of update data has been downloaded. In this case, there is also required, for example, an identifier indicating that the new update data is not yet downloaded, and this identifier may be represented by, e.g., “0” expressed by 1 bit. Note that a downloading technology applicable when the basic OS downloads the update data will be explained later on.

The dedicated OS, when booted, reads the update data partition and judges whether a new piece of update data is written or not. At this time, if provided with the flag partition, the dedicated OS may make the judgment by reading the identifier written in the flag partition. The dedicated OS thus judges based on the identifier written in the flag partition and thereby enables the judgment to be made quicker than in the case of judging a time sequence (new and old) about the respective update files. In this case, the dedicated OS may be configured to rewrite, after terminating the updating, the identifier of the flag partition into the identifier indicating that the new update data is not yet downloaded.

Moreover, the dedicated OS, if not provided with the flag partition, may judge whether the new update data is written or not by comparing individually a date and version information of the update data with a date and version information of the same category of data already recorded (stored) in the partition of the dedicated OS. In this case, the dedicated OS judges whether the new update data exists or not, and hence the flag partition becomes unnecessary.

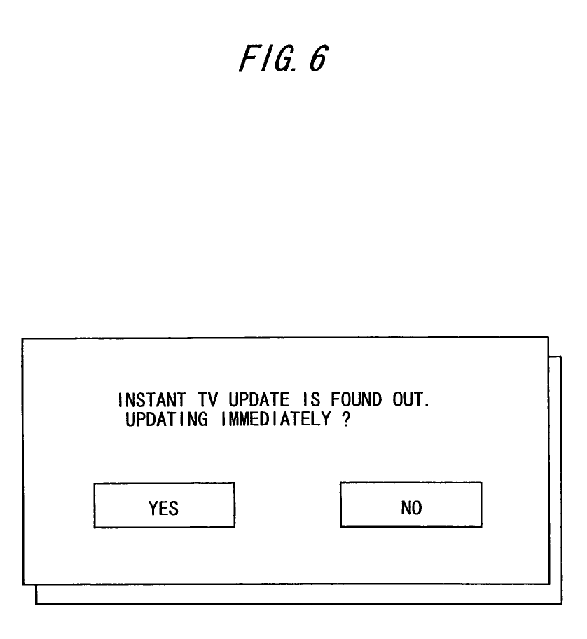

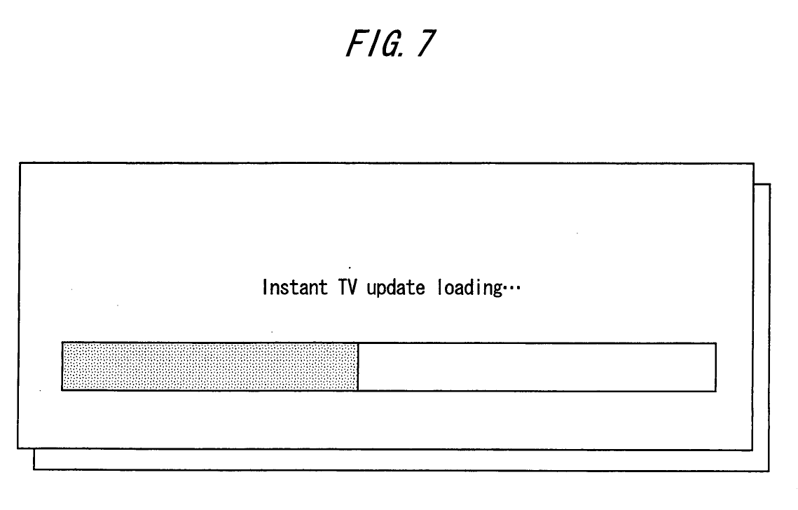

The dedicated OS, when judging that the new update data is written in the update data partition, executes updating that uses this piece of update data. At this time, the dedicated OS may be configured to prompt the user to make a choice as to whether the updating is carried out or not. The dedicated OS can prompt the user to select in a way that displays a representation (message) as shown in. e.g., FIG. 6 on the liquid crystal display 12. In a display example in FIG. 6, if the user selects “Yes” by using the cursor button 23 and the decision button 25 of the remote controller 2, the dedicated OS executes the updating that uses the new update data. In this instance, the dedicated OS can notify the user that the updating is executed by displaying the representation as shown in, e.g., FIG. 7 on the liquid crystal display 12. Further, in the display example in FIG. 6, if the user selects “No” by using the keyboard 3 and the unillustrated mouse, etc., the dedicated OS does not execute the updating that uses the new update data. In this case, when the user further inputs a purport that the updating is not conducted till a fresh piece of update data is downloaded next time, the dedicated OS may rewrite the identifier of the flag partition into the identifier indicating that the new update data is not yet downloaded without effecting the updating.

The dedicated OS, when executing the updating, at first cancels (deletes) the hibernate image and overwrites (updates) the update data on the necessary data, thus effecting the updating. Then, the dedicated OS creates again the hibernate image on the basis of the post-updating data and records (stores) the thus-created image. Note that the specific process for the updating described above may be executed not by the dedicated OS itself but by an update-oriented application operating on the dedicated OS.

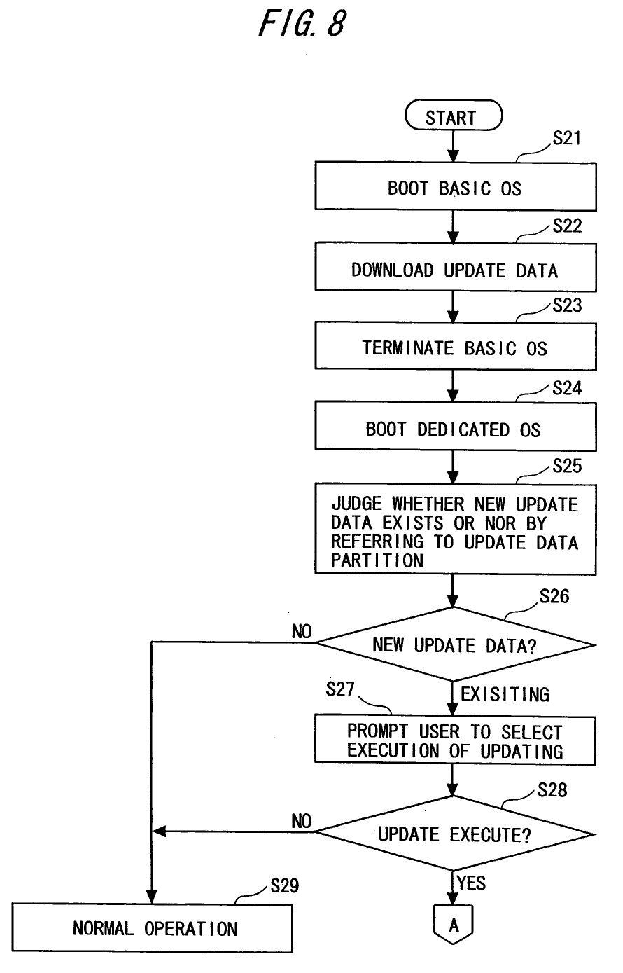

FIG. 8 is a flowchart showing an operational example of the device body 1 for the updating of the dedicated OS. The operational example of the device body 1 for the updating of the dedicated OS will hereinafter be described.

To begin with, the basic OS is booted by the user (S21), and, when given an instruction to download the update data, for example, download software installed in the basic OS accesses the server S and downloads the new update data (S22). At this time, the update data downloaded afresh by the basic OS or the download software running on the basic OS is written in the update data partition, wherein a value of the flag partition is rewritten. An example of the technology of thus searching for and downloading the new update data from the server S will be explained later on. After the basic OS has been terminated (S23), when the dedicated OS is booted on the same device body 1 (S24), the dedicated OS refers to the update data partition and thus judging whether the new update data exists or not (S25). For instance, the dedicated OS can make the judgment as to the existence or non-existence of the new update data by referring to the identifier of the flag partition. If the new update data does not exist (S26—non-existing), the dedicated OS performs a normal operation (S29). In the case of the embodiment, the dedicated OS executes processes from S5 onward in the flowchart shown in FIG. 4. Whereas if the new update data exists (S26—existing), the dedicated OS prompts the user to select the execution of the updating by displaying the representation (the message) as shown in FIG. 6 on the liquid crystal display 12, and so on (S27). If the user does not select the execution of the updating (S28—NO), the dedicated OS performs the normal operation (S29).

While on the other hand, when the user selects the execution of the updating (S28—YES), the dedicated OS terminates a TV receiving application (S30). Note that if the TV receiving application (TV application) is not yet booted at this point of time, the dedicated OS has no necessity of executing this process (the process in S30). Next, the dedicated OS boots an update application. The update application, when booted, cancels the hibernate image of the dedicated OS (S31). Next, the update application reads the file written in the update data partition (S32), and updates (rewrites) the data on the dedicated OS (S33). Then, the update application, based on the updated data, creates and records (stores) the hibernate image (S34). The process in S34 may also be executed by the dedicated OS and by the TV receiving application. Further, on the occasion of the process in S33, a version of the update data updated on the dedicated OS may be written in the flag partition. The basic OS side can recognize the update version on the dedicated OS through this process.

With this scheme thus configured, even when the dedicated OS does not have the connecting function to the network N (i.e., the dedicated OS does not have the function of downloading the update data from the server S), the dedicated OS is capable of executing the updating that uses the update data downloaded via the network N by the basic OS. Accordingly, the provider, etc. of the dedicated OS is not required to take a measure such as storing the update data of the dedicated OS on the storage medium and sending the storage medium by mail.

Further, the dedicated OS side judges whether the new update data exists or not, and hence the user has no necessity of taking trouble to make the judgment about the existence or non-existence of the new update data.

Downloading of Update Data

Next, a specific technology applicable to the process in which the basic OS downloads the update data from the server S, will be explained. The technology in the following discussion is a technology applicable to the process in S22 in FIG. 8.

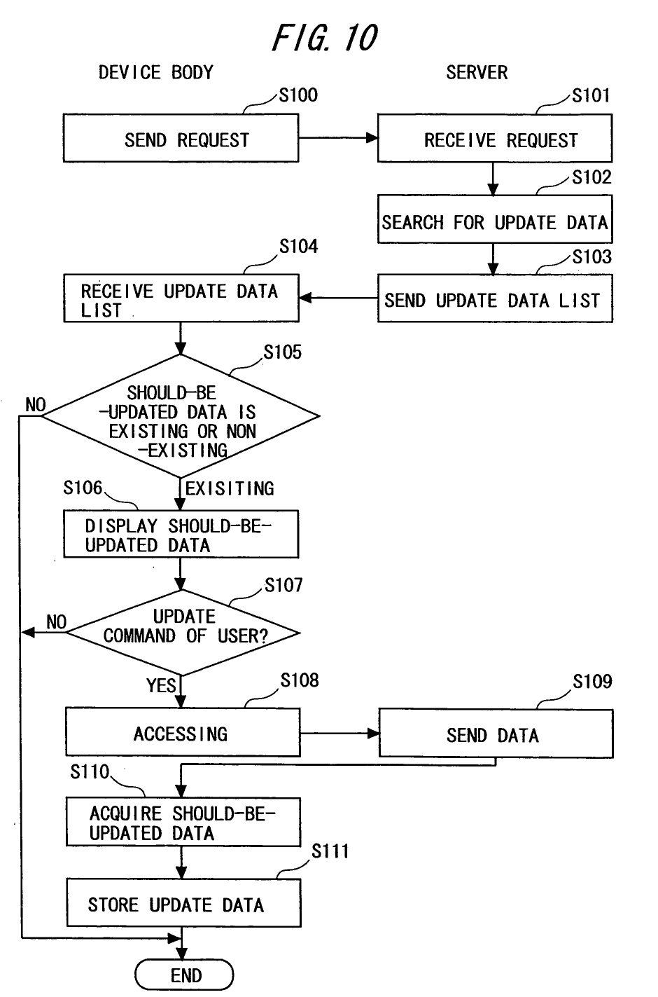

FIG. 10 is a sequence diagram for explaining the download process. This sequence is described on the assumption that the predetermined program according to the invention is executed, and the device body 1 operates under the control of this program.

The device body 1, after executing the predetermined program according to the invention that is preinstalled into the device body 1, upon detecting a predetermined event or the like, sends, via the network N to the server S, a request containing environment specifying information for specifying the update data that should be downloaded (S100). The predetermined event is exemplified such as a download instruction input from the input device connected to the device body 1, the arrival of preset timing and so forth. Further, the environment specifying information is exemplified such as information for specifying a name of machine type of the device body 1, information for specifying the dedicated OS preinstalled into the device body 1, information for specifying the application running on the dedicated OS, and so on. These categories of information may be used singly or may also be combined.

The server S receives the request from the device body 1 (S101) and searches a predetermined database for the information about the update data (update data) needed for the device body 1 on the basis of the environment specifying information (used as a search key) contained in this request (S102). The predetermined database is stored with an associated relation between the environment specifying information and pieces of update-related information (such as an update name, a downloading source URL (Uniform Resource Locator), a downloading source URL of Readme file associated with this update data, an update data size, an update data version, a disclosure date/time of the update data, etc.). Accordingly, the server S can search for (narrow down) the information about the update data associated with the environment specifying information by collating the environment specifying information contained in the request sent from the device body 1 with the predetermined database. The server S is an existing server enabling the user himself or herself to search for the update data. Thus, the network system can be built up at a low cost by utilizing the existing server by way of implementation of the server S. Note that the Readme file is defined as a file (text file) in which various categories of information about a function related to the update data corresponding to this file, an applicable device, items for attention required, a revised history, etc. are described in a so-called text format. The Readme file is created with a file name such as Readme.txt.

The server S, when searching for the information about the update data, generates an update data list containing a search result, and sends this list to the device body 1 as a requester (S103). The update data list is a list containing the information about the update data needed for the dedicated OS on the device body 1.

The device body 1 receives the update data list from the server S (S104), and stores this list on a self-possessed internal memory, etc. The device body 1 judges based on a predetermined condition whether or not the update data that should be updated exists in the update data list (S105). Namely, the device body 1 selects the update data that should be updated. Among pieces of update data in the update data list, the same update data as the data already installed into the device body 1 is not required to be re-installed into the device body 1. Therefore, in the process in S105, the device body 1 selects the update data that should be updated so as not to re-install the already-installed update data.

The judgment as to whether the update data that should be updated exists or not may be made based on any type of criterion. One example of a judging method will be explained.

The device body 1, when receiving the update data list from the server S, accesses the Readme file downloading source URL in the list, and thus downloads the Readme file. Note that if the list contains a plurality of Readme file downloading source URLs, the device body 1 accesses the respective URLs and downloads the plurality of Readme files.

The device body 1 compares the disclosure date/time of the update data in the information contained in the Readme file with the disclosure date/time of the already-downloaded update data. The device body 1 judges based on this comparison whether the Readme file downloaded a short while ago or the update data corresponding to this Readme file is new or not. Thus, accuracy of judgment can be more enhanced by making the judgment based on the disclosure date/time comparison than in a case of the judgment based on a version comparison. The following is a reason why so. For example, supposing that the server S has a bug-affected piece of uploaded update data of the latest version and consequently the update data of the old version is again uploaded and disclosed if the time sequence (new and old) judgment is made based on the versions, the version of the update data uploaded on the server S is older than the version of the already-downloaded update data, and hence the device body 1 judges that there is no necessity of downloading this data from the server S. This method is adaptable to such a case, thereby enhancing the accuracy of judgment.

When a result of the judgment is that the Readme file (or the update data corresponding to this Readme file) downloaded a short while ago is not new, the update data corresponding to this Readme file is excluded from an update target file. Namely, in this case, this update data is not selected. While on the other hand, when judging that the Readme file (or the update data corresponding to this Readme file) is new, the update data corresponding to this Readme file is selected as the update target file.

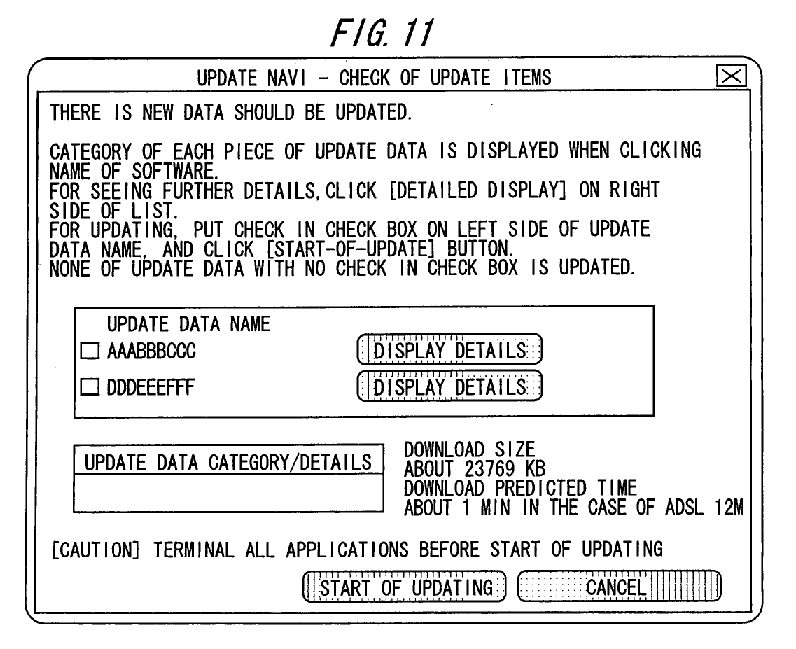

When the update data that should be updated is selected, the device body 1 displays the information about all pieces of update data set as the update target files on the liquid crystal display 12 (S106). FIG. 11 is a diagram showing a display example on the liquid crystal display 12. The device body 1, when the update button shown in FIG. 11 is pressed by clicking or otherwise (S107), accesses the downloading source URL of the update data selected as the update target data (S108), and downloads the update data corresponding thereto (S109, S110). Then, the device body 1 writes the downloaded update data in the update data partition. At this time, if the flag partition is provided, the device body 1 rewrites the identifier of the flag partition into an identifier indicating that the new update data has been downloaded (S111).

As discussed above, in the embodiment, the server S narrows down the update data needed in the device body 1 and sends the update data as the update data list to the device body 1. Accordingly, a communication quantity (traffic) across the network can be reduced as compared with the case of transmitting all pieces of update data to the device body 1 without performing the narrow-down process described above. Further, the downloading of the update data can be also automated by omitting the user's input in S107.

1. An information processing device comprising:
a controlling unit controlling conditions for receiving television broadcasting through an operating system;
a receiving unit receiving the television broadcasting signal in accordance with the receiving condition;
a first detecting unit detecting a first user's operation;
a second detecting unit detecting a second user's operation; and
a booting unit booting a first operating system for providing an information processing function according to the first user's operation, and booting a second operating system for providing a function of receiving the television broadcasting signal according to the second user's operation.

2. An information processing device according to claim 1, further comprising a recording unit storing said first operating system in a first recording area recognized based on first identifying information, and storing said second operating system in a second recording area recognized based on second identifying information but unrecognizable based on the first identifying information,
wherein said booting unit reads said first operating system from said first recording area recognized based on the first identifying information according to the first user's operation, and reads said second operating system from said second recording area in a way that replaces the first identifying information and the second identifying information with each other, according to the second user's operation.

3. An information processing device according to claim 1, wherein said booting unit boots said second operating system in a way that omits part of a booting process of said first operating system.

4. An information processing device according to claim 2, wherein said booting unit judges whether the second recording area recognized based on the second identifying information exists or not, and boots said first operating system, if unable to recognize the existence of the second recording area.

5. An information processing device according to claim 3, wherein the omitted process is a security check about resources or information managed by said operating system.

6. A computer program for making a computer receives television broadcasting signal, the computer program comprising the step of:
detecting a first user's operation or a second user's operation;
booting a first operating system for providing an information processing function according to the first user's operation;
booting a second operating system for providing a function of receiving the television broadcasting signal according to the second user's operation; and
controlling conditions for receiving television broadcasting signal via said first operating system or said second operating system, and thus receiving the television broadcasting signal.

7. A computer program according to claim 6, wherein said computer is connected to recording unit including a first recording area recognized based on first identifying information and a second recording area recognized based on second identifying information but unrecognizable based on the first identifying information, said first recording area is stored with said first operating system, while said second recording area is stored with said second operating system, and
said step of booting includes a step of, reading said first operating system from said first recording area recognized based on the first identifying information accord0ing to the first user's operation, and reading said second operating system from said second recording area in a way that replaces the first identifying information and the second identifying information with each other, according to the second user's operation.

8. A computer program according to claim 6, wherein said step of booting involves booting said second operating system in a way that omits part of a booting process of said first operating system.

9. A computer program according to claim 7, wherein said booting step of booting includes a step of, judging whether the second recording area recognized based on the second identifying information exists or not, and booting said first operating system, if unable to recognize the existence of the second recording area.

10. A computer program according to claim 8, wherein the omitted process is a security check about resources or information managed by said operating system.

11. A television broadcasting signal receiving method comprising:
detecting a first user's operation or a second user's operation;
booting a first operating system for providing an information processing function according to the first user's operation, and booting a second operating system for providing a television broadcasting signal receiving function according to the second user's operation; and
controlling conditions for receiving television broadcasting signal via said first operating system or said second operating system, and thus receiving the television broadcasting signal.

12. A television broadcasting signal receiving method according to claim 11, wherein a first recording area recognized based on first identifying information is stored with said first operating system, and a second recording area recognized based on second identifying information but unrecognizable based on the first identifying information is stored with said second operating system, and
when booting, reading said first operating system from said first recording area recognized based on the first identifying information according to the first user's operation, and reading said second operating system from said second recording area in a way that replaces the first identifying information and the second identifying information with each other, according to the second user's operation.

13. A television broadcasting signal receiving method according to claim 11, when booting, booting said second operating system in a way that omits part of a booting process of said first operating system.

14. A television broadcasting signal receiving method according to claim 12, when booting, judging whether the second recording area recognized based on the second identifying information exists or not, and booting said first operating system, if unable to recognize the existence of the second recording area.

15. A television broadcasting signal receiving method according to claim 13, wherein the omitted process is a security check about resources or information managed by said operating system.

16. An information processing device on which a first operating system and a second operating system are operable, comprising:
a receiving unit receiving a boot instruction of said operating system; and
a controlling unit performing management by making a first recording area recognizable to said first operating system booted according to the boot instruction while said first operating system stored in said first recording area is running, and making a second recording area storing the second operating system unrecognizable.

17. An information processing device according to claim 16, wherein said first recording area and said second recording area are recognized by said operating system based on first identifying information but not recognized based on second identifying information, and
wherein said control unit executes such setting that the first recording area is managed based on the second identifying information, and boots said second operating system, when booting said second operating system according to the boot instruction.

18. An information processing device according to claim 17, wherein said booting unit boots said second operating system in a way that omits part of a booting process of said first operating system.

19. An information processing device according to claim 17, wherein said booting unit judges whether the second recording area recognized based on the second identifying information exists or not, and boots said first operating system, if unable to recognize the existence of the second recording area.

20. An information processing device according to claim 18, wherein the omitted process is a security check about resources or information managed by said operating system.

21. A computer program running on a computer on which a first operating system and a second operating system are operable, the computer program comprising the step of:
receiving a boot instruction of said operating system; and
controlling for performing management by making a first recording area recognizable to said first operating system booted according to the boot instruction while said first operating system stored in said first recording area is running, and making a second recording area storing the second operating system unrecognizable.

22. A computer program according to claim 21, wherein said first recording area and said second recording area are recognized by said operating system based on first identifying information but not recognized based on second identifying information, and
wherein said step of controlling makes said computer execute instructions for booting as above, when booting said second operating system according to the boot instruction, booting said second operating system by executing such setting that the first recording area is managed based on the second identifying information.

23. A computer program according to claim 22, wherein said step of booting involves booting said second operating system in a way that omits part of a booting process of said first operating system.

24. A computer program according to claim 22, wherein said booting step includes a step of, judging whether the second recording area recognized based on the second identifying information exists or not, and booting said first operating system, if unable to recognize the existence of the second recording area.

25. A computer program according to claim 23, wherein the omitted process is a security check about resources or information managed by said operating system.

26. A control method of an information processing device on which a first operating system and a second operating system are operable, comprising:
receiving a boot instruction of said operating system; and
controlling for performing management by making a first recording area recognizable to said first operating system booted according to the boot instruction while said first operating system stored in said first recording area is running, and making a second recording area storing the second operating system unrecognizable.

27. A control method according to claim 26, wherein said first recording area and said second recording area are recognized by said operating system based on first identifying information but not recognized based on second identifying information, and
in controlling, booting said second operating system by executing such setting that the first recording area is managed based on the second identifying information, when booting said second operating system according to the boot instruction.

28. A control method according to claim 27, when booting, booting said second operating system in a way that omits part of a booting process of said first operating system.

29. A control method according to claim 27, when booting, judging whether the second recording area recognized based on the second identifying information exists or not, and booting said first operating system, if unable to recognize the existence of the second recording area.

30. A control method according to claim 28, wherein the omitted process is a security check about resources or information managed by the operating system.

31. An information processing device according to claim 2, further comprising:
a downloading unit downloading, via the network, data used during an operation of said second operating system during an operation of said first operating system,
wherein said recording unit further includes a third recording area recognized by both of said first operating system and said second operating system, and
said downloading unit records the downloaded data in the third recording area.

32. An information processing device according to claim 31, wherein the data downloaded by said downloading unit is data used during the operation of said second operating system and serving to update a program of said second operating system, and said information processing device further comprises an updating unit updating the program of said second operating system by use of the data recorded in the third recording area during the operation of said second operating system.

33. An information processing device according to claim 16, further comprising a downloading unit downloading, via the network, the data used during the operation of said second operating system during the operation of said first operating system and recording the downloaded data in the third recording area, and
wherein said control unit makes the third recording area recognizable from said first operating system in an operating status of said first operating system and makes the third recording area recognizable from said second operating system in an operating status of said second operating system.

34. An information processing device according to claim 33, wherein the data downloaded by said downloading unit is data used during the operation of said second operating system and serving to update a program of said second operating system, and
said information processing device further comprises updating unit for updating the program of said second operating system by use of the data recorded in the third recording area during the operation of said second operating system.

35. A computer program according to claim 7, wherein said recording unit further includes a third recording area recognizable by both of said first operating system and said second operating system, and
wherein said computer program further comprises a step of:
downloading, via the network, the data used during the operation of said second operating system during the operation of said first operating system and serving to update a program of said second operating system;
recording the downloaded data in the third recording area; and
updating the program of said second operating system by use of the data recorded in the third recording area during the operation of said second operating system.

36. A computer program according to claim 21, further comprising the step of:
downloading, via the network, the data used during the operation of said second operating system during the operation of said first operating system and serving to update a program of said second operating system;
recording the downloaded data in the third OS-recognizable recording area recognizable by both of said first operating system and said second operating system; and
updating the program of said second operating system by use of the data recorded in the third recording area during the operation of said second operating system.

37. A television broadcasting signal receiving method according to claim 12, wherein a third recording area recognizable by both of said first operating system and said second operating system is further provided, and
wherein said method further comprises:
downloading, via the network, the data used during the operation of said second operating system during the operation of said first operating system and serving to update a program of said second operating system;
recording the downloaded data in the third recording area; and
updating the program of said second operating system by use of the data recorded in the third recording area during the operation of said second operating system.

38. A control method according to claim 27, further comprising:
downloading, via the network, the data used during the operation of said second operating system during the operation of said first operating system and serving to update a program of said second operating system;
recording the downloaded data in the third recording area recognizable by both of said first operating system and said second operating system; and
updating the program of said second operating system by use of the data recorded in the third recording area during the operation of said second operating system.

39. An information processing device comprising:
a recording unit including a first recording area recognized during an operation of a first operating system, a second recording area recognized during an operation of a second operating system and a third recording area recognized even during the operation of either said first operating system or said second operating system;
a network connecting unit transmitting and receiving data via a network during the operation of said first operating system;
a downloading unit downloading the data used during the operation of said second operating system through said network connecting unit during the operation of said first operating system, and recording this data in the third recording area; and
an executing unit executing a process by use of the data written in the third recording area during the operation of said second operating system.

40. An information processing device according to claim 39, wherein the downloading unit, when downloading a new piece of data, writes in the third recording area a first identifier indicating that the new data is recorded in the third recording area, and
said executing unit, when executing the process by use of the new data, writes in the third recording area a second identifier indicating that the new data is not recorded in the third recording area as a substitute for the first identifier.

41. An information processing device according to claim 40, wherein the third recording area includes a full-access recording area enabling the data to be read from and written in even during an operation of either said first operating system or said second operating system, and an access restriction recording area enabling the data to be read from and written in during the operation of said first operating system and enabling the data to be only read from during the operation of said second operating system,
said downloading unit writes the downloaded data in the access restriction recording area and writes the first identifier in the full-access recording area, and
said executing unit writes the second identifier in the full-access recording area.

42. An information processing device according to claim 38, wherein said executing unit, when said second operating system is booted, judges whether or not the first identifier is written in the third recording area, and, when the first identifier is written therein, executes the process by use of the data written in the third recording area.

43. An information processing device according to claim 39, further comprising booting unit for booting said second operating system by recording a content of a main memory during the operation of said second operating system in the second recording area, and by recovering, when booting said second operating system, the content of the main memory that has been recorded in the second recording area back to the main memory, and aid executing unit deletes from the second recording area the content of the main memory that has been recorded by said booting unit, and next executes updating said second operating system by use of data for updating a content of said second operating system in the data written in the third recording area, and said booting unit records, after being updated by said executing unit, the content of the main memory during the operation of said second operating system again in the record recording area.

44. A computer program for executing an information processing device comprising recording unit including a first recording area recognized during an operation of a first operating system, a second recording area recognized during an operation of a second operating system and a third recording area recognized even during the operation of either said first operating system or said second operating system, execute;
downloading data used during the operation of said second operating system during the operation of said first operating system, and recording this data in the third recording area; and
executing a process by use of the data written in the third recording area during the operation of said second operating system.

45. A download method, in an information processing device comprising recording unit including a first recording area recognized during an operation of a first operating system, a second recording area recognized during an operation of a second operating system and a third recording area recognized even during the operation of either said first operating system or said second operating system, comprising;
making the information processing device download data used during the operation of said second operating system during the operation of said first operating system, and record this data in the third recording area; and
making said information processing device execute a process by use of the data written in the third recording area during the operation of said second operating system.
